(19) United States
(12) Patent Application Publication
(10) Pub. No.: US 2011/0191039 A1
(43) Pub. Date: Aug. 4, 2011

(54) SHOCK WAVE GENERATOR FOR BIOMEDICAL STUDIES

(76) Inventors: Stanislav I. Svetlov, (US); Daniel R. Kirk, Melbourne, FL (US); Hector Gutierrez, Melbourne, FL (US); Kevin Ka-wang Wang, Gainesville, FL (US); Ronald L. Hayes, Alachua, FL (US)

(21) Appl. No.: 12/975,576

(22) Filed: Dec. 22, 2010

Related U.S. Application Data
(60) Provisional application No. 61/288,932, filed on Dec. 22, 2009.
(60) Provisional application No. 61/424,484, filed on Dec. 17, 2010.

(51) Int. Cl. G06F 19/00

(52) U.S. Cl. 702/50

(57) ABSTRACT

A process of measuring blast shock includes exposing a shock model to an output of a shockwave generator. The propagation of the output is sensed with a sensor platform to generate sensor wave propagation data. The data recorded by the sensor platform is analyzed to measure the blast shock. The blast shock alone or as a component of a cumulative blast exposure can be correlated with an injury metric. A system for measuring cumulative blast shock is provided that includes a sensor platform and an algorithm operating on a microprocessor for analyzing the data recorded by the sensor platform to measure the cumulative blast exposure to injury metrics.

### CROSS REFERENCE TO RELATED APPLICATIONS

This application claims priority to U.S. Provisional Application No. 61/288,932 filed Dec. 22, 2009 and Provisional Application No. 61/424,484 filed on Dec. 17, 2010, the entire contents of which are incorporated herein by reference.

### FIELD OF THE INVENTION

The present invention relates to an experimental platform for the generation of controlled and repeatable blast pressures for the recordation of cumulative blast data and for the study of the effect of blast events on live and inanimate test specimen and correlation of a neurological condition to an individual and in particular to study of and measuring a quantity of biomarkers of blast polytrauma, including brain injury and neuropredictive conditional biomarker(s).

### BACKGROUND OF THE INVENTION

The field of clinical neurology remains frustrated by the recognition that secondary injury to a central nervous system tissue associated with physiologic response to the initial insult could be lessened if only the initial insult could be rapidly diagnosed or in the case of a progressive disorder before stress on central nervous system tissues reached a preselected threshold. Traumatic, ischemic, and neurotoxic chemical insult, along with generic disorders, all present the prospect of brain damage. While the diagnosis of severe forms of each of these causes of brain damage is straightforward through clinical response testing and computed tomography (CT) and magnetic resonance imaging (MRI) testing, these diagnostics have their limitations in that spectroscopic imaging is both costly and time consuming while clinical response testing of incapacitated individuals is of limited value and often precludes a nuanced diagnosis. Additionally, owing to the limitations of existing diagnostics, situations under which a subject experiences a stress to their neurological condition such that the subject often is unaware that damage has occurred or seek treatment as the subtle symptoms often quickly resolve. The lack of treatment of these mild to moderate challenges to neurologic condition of a subject can have a cumulative effect or subsequently result in a severe brain damage event which in either case has a poor clinical prognosis.

In order to overcome the limitations associated with spectroscopic and clinical response diagnosis of neurological condition, there is increasing attention on the use of biomarkers as internal indicators of change as to molecular or cellular level health condition of a subject. As detection of biomarkers uses a sample obtained from a subject and detects the biomarkers in that sample, typically cerebrospinal fluid, blood, or plasma, biomarker detection holds the prospect of inexpensive, rapid, and objective measurement of neurological condition. The attainment of rapid and objective indicators of neurological condition allows one to determine severity of a non-normal or anomalous brain condition on a scale with a degree of objectivity, predict outcome, guide therapy of the condition, as well as monitor subject responsiveness and recovery. Additionally, such information as obtained from numerous subjects allows one to gain a degree of insight into the mechanism of brain injury.

Analyses of mechanisms and development of biomarkers of blast brain injury (BBI) has been complicated by a deficiency of quality experimental studies and the lack of a reliable experimental platform for studies of blast-related injury. Blast generators (shock tubes) are increasingly being utilized for blast trauma studies on simulated human targets. Interpretation and repeatability of these studies are complicated by inconsistent designs among shock tubes such that the data on injury mechanisms, including brain damage, are difficult to analyze and compare. This is particularly true if the experimental shock waves are not properly characterized. Furthermore, existing shock wave generators fail to include a process of measuring cumulative blast, and none to date have associated the dynamics of cumulative blast to actual injury, including BBI.

The use of shock tubes and blast tubes is currently the most widely accepted method for experimental subscale simulation of exposure to blast in animal studies. Shock tubes and blast tubes can only mimic the pressure events of actual explosions on a small region of their workspace relative to the diameter of the driven chamber, and their fidelity in recreating a sub-scale blast event is therefore limited by the dimensions of the shock tube. A practical design for animal studies requires a careful compromise between the size of the shock tube relative to the size of a test specimen, ease and safety of operation and fidelity in creating a pressure field that resembles that of an actual blast event at the desired exposure points on the test specimen.

Estimation of the pressure wave acting on the test specimen is typically done by developing detailed pressure maps in the workspace of the shock tube in absence of a test sample, assuming later than the pressure distribution on the actual test specimen will closely resemble that of the previously mapped pressure field. This assumption works well when the area of the specimen exposed to blast is small relative to the size of the specimen (e.g. head-directed blasts for traumatic brain injury studies in rodents) but becomes less and less accurate when exposure of large target areas (e.g. full-body exposure) is desired, since the interaction between the blast wave and the target alters the pressure distribution in points of the specimen downstream from the first point of impact.

Once a methodology to create sub-scale repeatable blast events can be developed, peak overpressure, duration and transmitted impulse can be controlled to replicate pressure blast events scaled to an equivalent amount of TNT, as function of the distance to the blast source. This information may be used to investigate metrics used to characterize the blast-target interaction including: (a) The restitution coefficient between a target and an incoming shock wave, for both rigid and visco-elastic targets, which includes: (i) Modeling the restitution coefficient between a blast wave and a target based on wave propagation theory, (ii) Development of high-speed imaging techniques to measure the restitution coefficient between a target and an incoming blast wave; and (b) The strain rate vector of a target, both rigid and viscoelastic, subject to an incoming shock wave.

Micro-electronic radiation and chemical exposure detectors are available to track peak levels and, to some extent, cumulative history. However, there are no such devices available for exposure to multiple blasts or impulse. Military medical officials hope to place a sensor on every soldier to be able to measure the impact of a blast while alerting a combat medic to the possibility of a brain injury. Their hope is to one day provide personnel with personal blast sensors to be carried with them to record the cumulative blast seen by those personnel. The sensor data would be recorded along with other operational data typically gathered after an event such as an explosion. The data would be entered into the National Ground Intelligence Center, already being used in the field, and the medical community will have access to it through the Joint Trauma Analysis and Prevention of Injury in Combat Program. If new exposure occurs to the same serviceman, previous data recorded in a trauma registry would be readily available.

Instrumentation of live test specimens to assess blast-related injury has historically proven to be a challenge. Conventional pressure, acceleration and rate of rotation transducers are relatively large (relative to the size of a test rodent), and wiring introduces further distortion in the incoming pressure wave as it approaches the sample. Animal test subjects are typically supported on a solid or meshed surface, which further distorts the experimentally-created exposure to blast relative to actual conditions on the field, in which the target is free to move as a result of the explosion, and reflections from neighboring surfaces may or may not be present. Another important question that is yet to be addressed is how to quantify the cumulative effect of blast exposure in live test specimens subject to successive blasts.

While there has been minimal experimental and numerical studies describing the interaction between blast waves and fixed targets such as rigid plates, nothing has been developed to examine what happens when a target is allowed to move freely after being hit by a blast. In animal testing, the test specimens are affixed to a structure and not allowed to move in response to the blast wave. Such arrangement is very different from the more common situation when the target is propelled away by the blast.

A number of “wearable” devices have been proposed to collect blast exposure information from soldiers deployed in the field, and some are currently under development. However, a connection must be made between blast exposure levels and injury metrics, or otherwise the data gathered cannot be used by personnel on the field to make medical decisions. It is clear that a wearable device must be calibrated against injury metrics to be useful. This feat cannot be accomplished, however, until a novel and more comprehensive metrics of target-blast interaction is developed. The first phase of providing this metric is the construction of a device to create sub-scale repeatable blast events.

A common drawback found in many shock tube blast studies comes from placing the target along the axis of the shock wave generator. This creates exposure to a gas venting jet: after the shock wave passes, the exhaust of the gas used to create the wave substantially alters the pressure and impulse at the target as it vents. Thus, experimental analyses that fail to account for the multiple pressures and magnitude of such complicate interpretation of results and extension to field produced injuries.

Thus, there exists a need for a controlled blast generator suitable for repeatable experimental use with a well characterized and defined blast impact for providing improved measurement and study of neurological condition. Furthermore there exists a need for a process of recording cumulative blast events and relating the information to injury metrics in the body of a victim subjected to blast exposure with such metrics including biomarker release and physiological tissue changes.

### SUMMARY OF THE INVENTION

A process of measuring blast shock includes exposing a shock model to an output of a shockwave generator and a system for measuring cumulative blast shock is provided that includes a sensor platform and an algorithm operating on a microprocessor for analyzing the data recorded by the sensor platform to measure the cumulative blast exposure to injury metrics. The shockwave generator implements a novel shock tube design that incorporates several improvements relative to previously existing devices is presented. The proposed shock tube design provides better fidelity in recreating sub-scale blast events over a larger target area while staying within size, cost and operational constrains that make its implementation practical. The propagation of the output is sensed with a sensor platform to generate sensor wave propagation data. The sensor platform provides simultaneous acquisition of various blast measurements, including, but not limited to, pressure, acceleration and rate of rotation at multiple points on an unconstrained live target while minimally affecting the interaction between the blast pressure wave and the test specimen. Furthermore the sensor platform allows for data recording of cumulative blast sensor information to solid-state memory, and untethered operation achieved by a microprocessor-based data acquisition and storage design that incorporates state-of-the-art miniature sensors, solid-state memory and compact lightweight batteries, being therefore small enough to be attached to a test specimen without need of external wiring. The data recorded by the sensor platform is analyzed to measure the blast shock. The blast shock alone or as a component of a cumulative blast exposure can be correlated with an injury metric.

### BRIEF DESCRIPTION OF THE DRAWINGS

FIG. 1 depicts one embodiment of an inventive shockwave generator for generation of a controlled, sub-scale blast event;

FIG. 2 depicts an exemplary shock wave produced by the present invention;

FIG. 3 represents the hardware architecture of the proposed sensor platform.

FIG. 4 shows confined target studies with impervious and mesh backing plates and the shock wave interaction therewith.

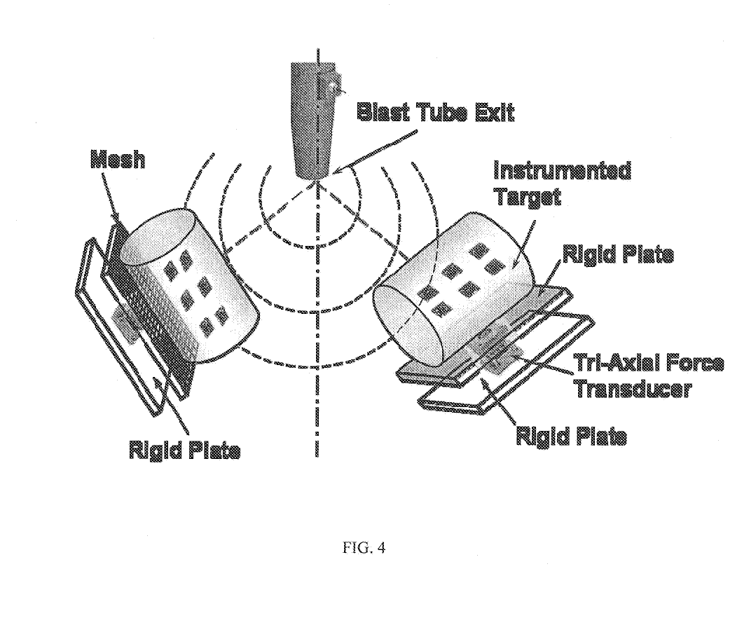

FIG. 5 shows a free-to-accelerate scenario, measuring full 6 degrees of freedom (DOF) motion of target due to blast wave interaction.

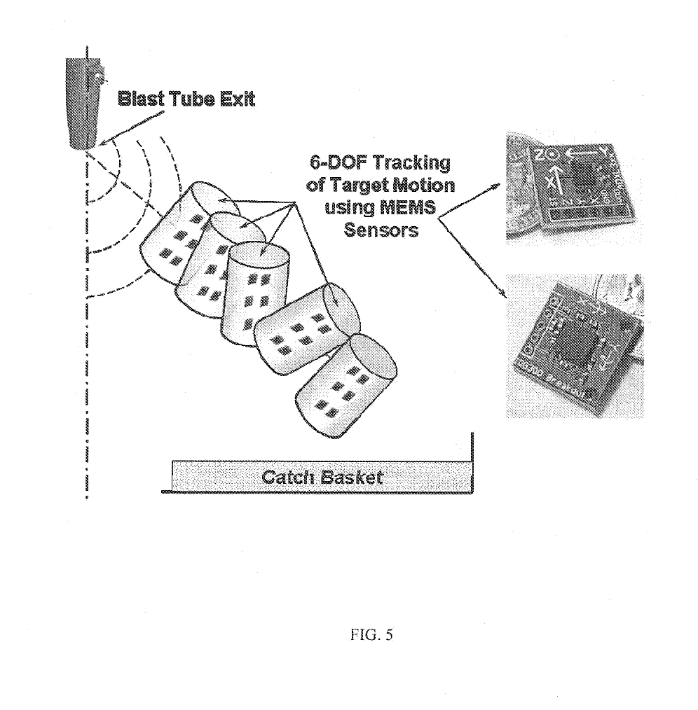

FIG. 6 illustrates one region for locating specimens outside the shock tube.

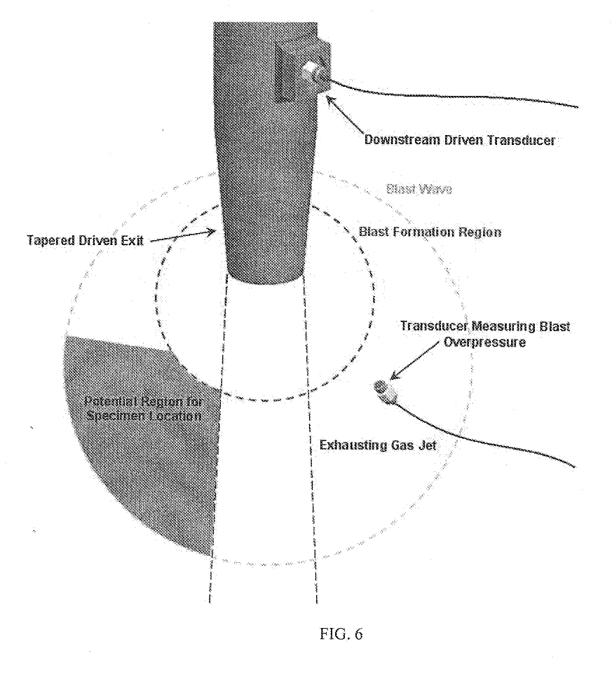

FIG. 7 represents a wave diagram illustrating blast wave formation inside a shock tube.

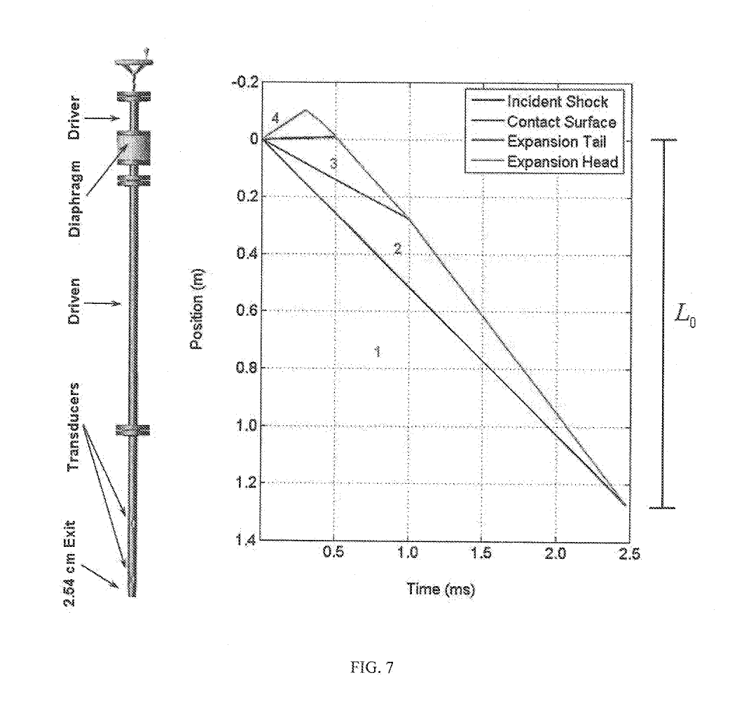

FIG. 8 depicts a pressure trace of the driven section showing the pressure history of a one-dimensional blast wave.

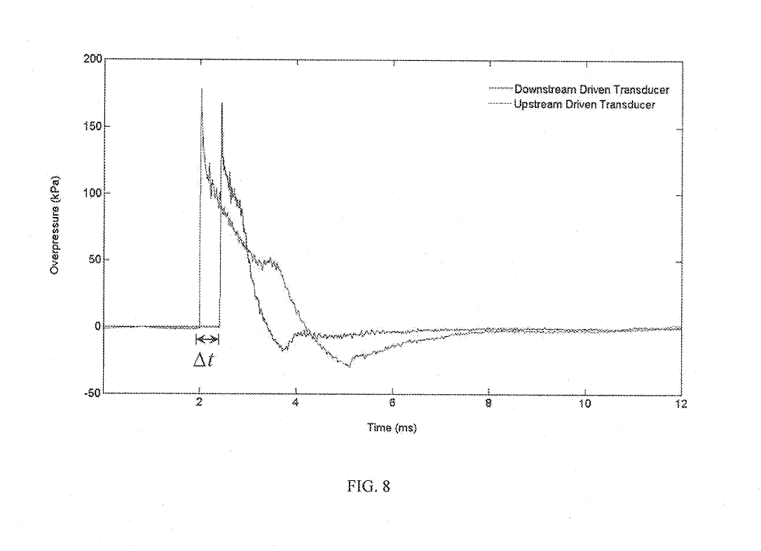

FIG. 9 represents Overpressure vs. Time for driver pressure/driven pressure=6.78 and Driven//Driver Length=80 at 7.62 cm and in line from the shock tube exit.

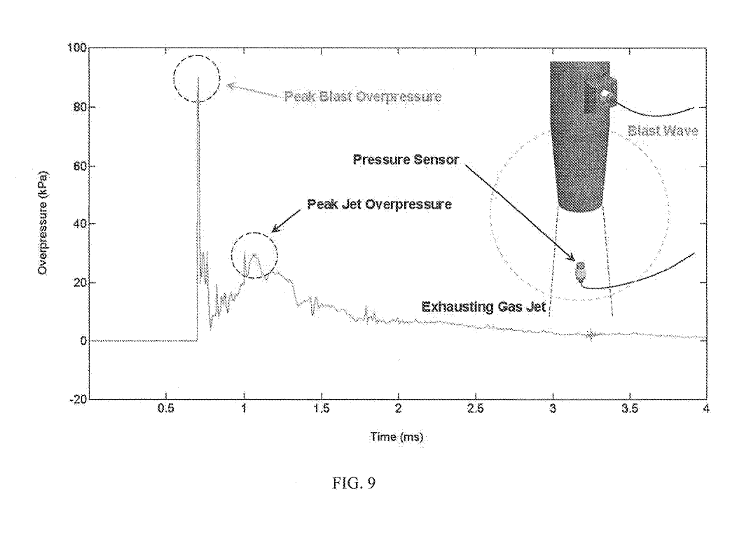

FIG. 10 represents Overpressure vs. Time for driver pressure/driven pressure=6.78 and Driven//Driver Length=15.75 at 7.62 cm and in line from the shock tube exit.

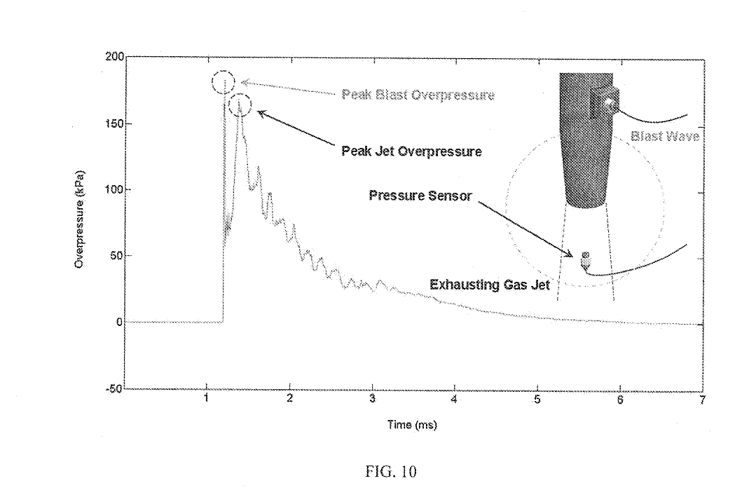

FIG. 11 represents Peak Blast Overpressure vs. radial distance from the shock tube exit normalized by shock tube diameter for driver pressure/driven pressure=52.02 and Driven//Driver Length=15 at various transducer angles, θ, relative to the axis of the shock tube.

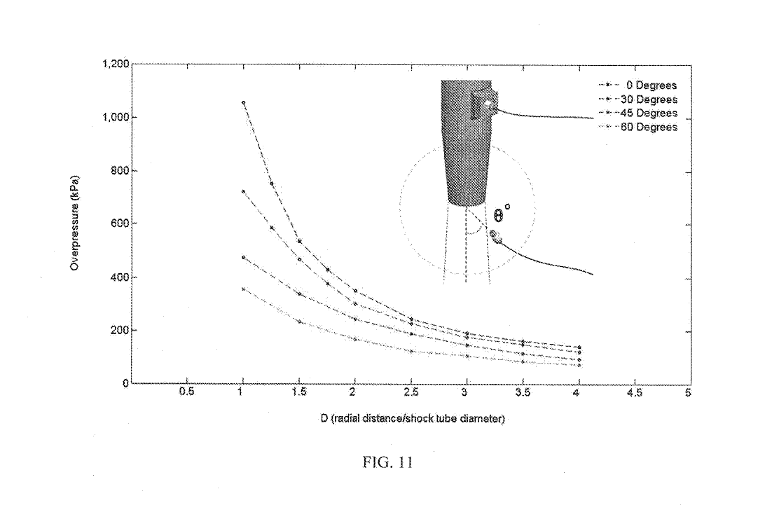

FIG. 12 represents Overpressure vs. Time for driver pressure/driven pressure=52.02 and Driven//Driver Length=15 measured at a radial location 10.16 cm from the shock tube's exit (θ=60°).

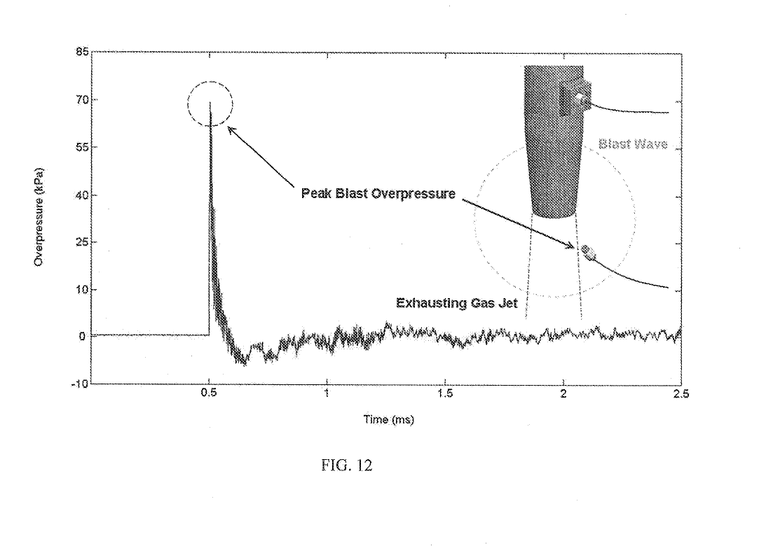

FIG. 13 illustrates pressure history of a blast wave showing positive and negative phase durations. Such waves may be characterized by the peak overpressure and duration of the positive phase.

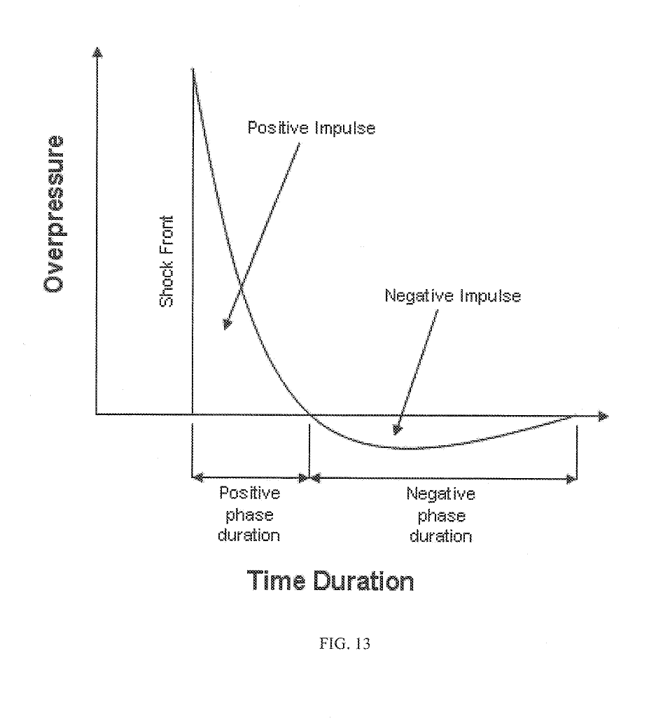

FIG. 14 provides an illustration of pressure decay with distance of a blast wave. The strength of the blast wave's shock front decays with distance away from the explosion.

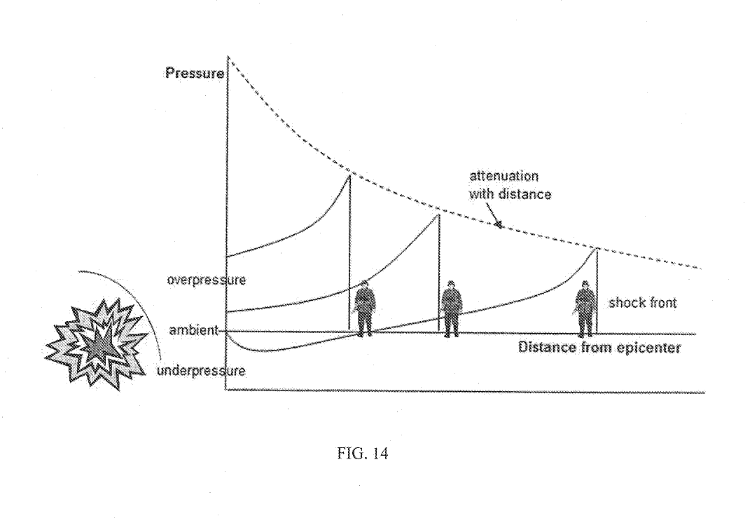

FIG. 15 represents subject brain injury following shock wave exposure to the present invention;

FIG. 16 represents GFAP levels in subject brain tissues following shock wave exposure to the present invention;

FIG. 17 represents CNPase levels in subject brain tissues following shock wave exposure to the present invention;

FIG. 18 represents GFAP levels in subject CSF and serum following shock wave exposure to the present invention;

FIG. 19 represents NSE concentration in subject CSF and serum following shock wave exposure to the present invention;

FIG. 20 represents UCH-L1 levels in subject CSF and plasma following shock wave exposure to the present invention.

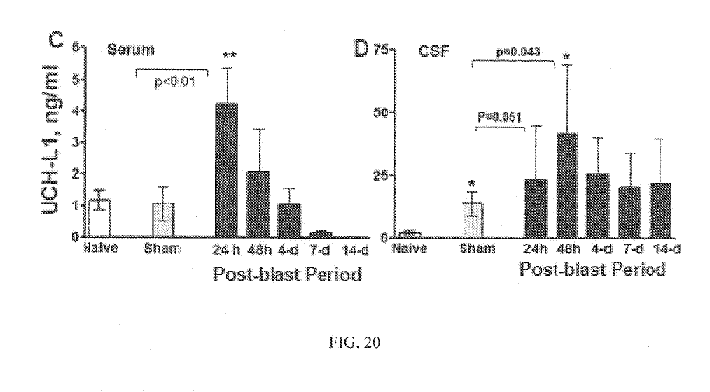

FIG. 21 represents GFAP and UCH-L1 levels in blood after off-axis head and total body blast following shock wave exposure.

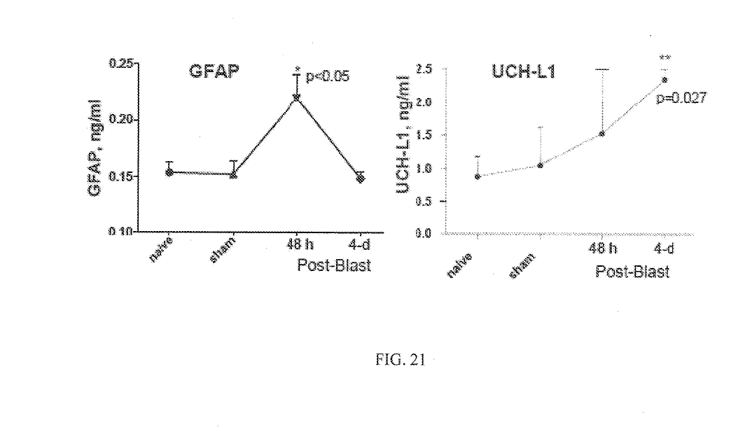

### DESCRIPTION OF THE PREFERRED EMBODIMENTS

The subject invention also has utility for generating controlled neurological trauma or condition predictive or indicative of future disease or present or future injury. Illustratively, the subject invention has utility as a safety or efficacy screening protocol in vivo or in vitro for drug development. Drug development is not limited to drugs directed to neurological conditions.

### Controlled Blast Generator

The inventive controlled blast generator presents a device that can produce unique wave signatures—either shock waves or blast waves, or ‘hybrid waves’ within the device itself, and can produce blast wave signatures external to the device. Its novel aspects include a variable geometry ‘driver’ and ‘driven’ sections to control wave formation while additionally providing a low profile, tapered ‘driven’ exit geometry. It is a scalable design that also includes a rapid exchange diaphragm section. It is preferred that the controlled blast generator be used in a testing methodology, which may use ‘on-axis’ pressure measurement, preferably ‘off-axis’ pressure measurement to eliminate contamination from exhausting driver gases.

The inventive controlled blast generator also provides the ability to provide measurement of the static pressure field, without any shock model present, which measurement may be performed as a function of radial distance away from tube exit and angle from tube axis. This allows for the assessment of pressure gradient in radial and angular direction as a function of tube operating conditions, and enables the measurement of total (reflected) pressure field without any shock models present.

The inventive controlled blast generator also provides a formal experimental testing methodology which correlates internal tube pressures to an external pressure field, measures and correlates static and total pressure at specimen location, and a high speed data acquisition system to measure various parameters indicative of a shock blast including, but not limited to, peak pressure, total impulse and positive and negative phase durations of blast waves.

The inventive controlled blast generator presents a modular design for the shock tube that provides the flexibility to perform repeatable blast experiments over a wide range of peak overpressure, pulse duration and transferred mechanical energy (impulse). The invention has utility as a controlled shockwave generator. The invention has further utility for the identification and study of biomarkers that diagnose, define, and differentiate the type and magnitude of neurological injury following impact trauma.

The inventive controlled blast generator is superior to other embodiments of a similar purpose in that the inventive blast generator allows for independent control of the static pressure, total impulse and phase duration as a function of tube settings (geometry and pressures), allows the scaling of the design to control pressure gradients (minimize) as a function of radial and angular location and capable to be operated in vertical or horizontal orientation. Additionally it allows for an optical measurement system to capture wave/specimen interaction and provides a rigid, semi-flexible and zero-resistance test model holder that enhances experimental testing methodology for biological applications

An inventive shockwave generator functions on the principle that sudden exposure of an ambient or lower pressure gas to a relatively higher pressure gas will result in the formation of a shock wave that propagates into the lower pressure gas. A shock model is exposed to the controlled output of the generator to test the impact of the shock wave on the model. As used herein, a shock model is defined as a test animal, cadaver, or a mechanical test device simulative or representative of a human or animal subject. It is appreciated that the efficacy protective wear imparts to a shock model or a subject in the field is readily tested by exposing the shock model to like shock generator outputs with and without the potentially protective equipment. An exemplary device is detailed in US 2005/0100873. The generator functions via a driven section to create a blast wave from a shock wave. The driven section length is preferably sized for varying driver section lengths; however the driven section may be constructed as a fixed length to reduce the number of connections, thereby reducing the incidence of leakage from the generator.

An inventive shockwave generator illustratively includes a driver section 100 connected to a driven section 102. The driven section 102 preferably has a first end 104 and a second end 106 wherein the second end terminates in an exit aperture 108. The driver section 100 and the driven section 102 preferably have a diaphragm disposed therebetween.

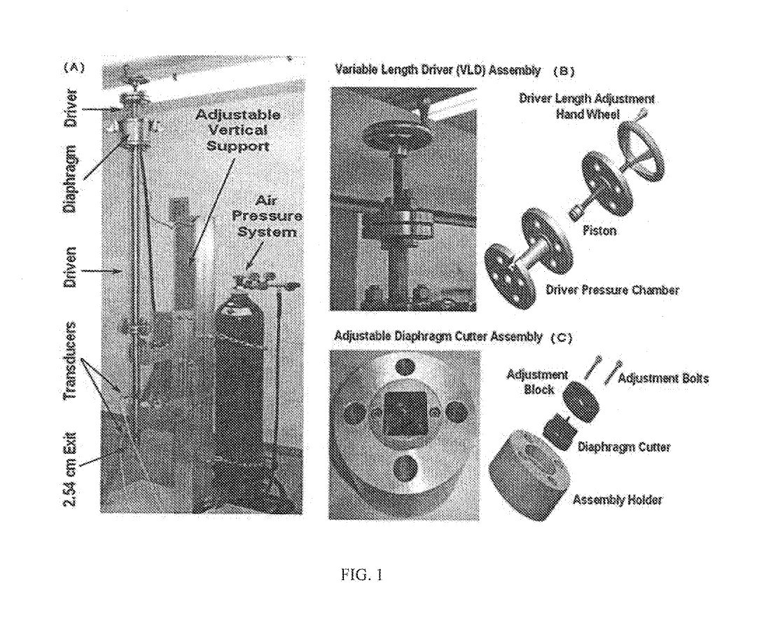

A driver section houses and optionally stores fluid at a pressure greater than that present in the driven section. As depicted in FIG. 1B, a driver section is preferably a variable length driver assembly (VLD) 110. A variable length driver assembly 110 illustratively includes a driver pressure chamber 112 which is a substantially cylindrical shaft open at both ends to accept a piston 114 movably inserted into the inner diameter of the driver pressure chamber shaft 112. The piston 114 is preferably connected to a driver length adjustment mechanism 116 which adjusts the position of the piston 114 vertically along the longitudinal axis of the driver pressure chamber 112. The presence of the piston 114 within the driver pressure chamber adjusts the volume of fluid present within the driver pressure chamber, hence present within the driver section to force the diaphragm against the cutter to fire the shockwave generator. The length of a driver section is adjustable by the presence of the movable piston 114 present in the driver pressure chamber. The length adjustment is scalable dependent on the inner diameter of the shock tube, however, preferably between 19 millimeters and 110 millimeters.

The components of a driver section are preferably made of a material of suitable rigidity so as to resist distortion or flexing when containing a fluid at pressures between 5 and 10,000 kPa. Preferred materials include metals such as stainless steel, steel, alloys including aluminum alloys, and rigid polymeric materials.

The inner diameter of a driver pressure chamber 112 is preferably between 1 cm and 34 cm. The small diameter allows the device to produce blast waves within the driven section of the tube. However, because of its small diameter, the blast wave exposure will be limited to a target area within the test specimen. Using a smaller diameter tube to produce total body exposure typically leads to large pressure gradients across the test specimen rather than a uniform pressure distribution over its entire area, as would be on a typical far-field explosion. To address this limitation a larger diameter shock tube is proposed, to allow a greater area of exposure on the test specimen where the effect of a far-field subscale blast event is correctly reproduced. It is appreciated that larger inner diameters are operable herein, however as the inner diameter increases, the size of the controlled shockwave generator will necessarily be larger, ultimately making the device inconvenient to house or operate. The benefit of the larger sized devices, however, will allow a more realistic and uniform replication of scaled blast events and allow for a more accurate profile of the blast pressure wave. More preferably a driver pressure chamber 112 is of suitable size to contain an interior volume to accept sufficient fluid to drive the inventive shockwave generator.

A piston 114 as positioned within the inner diameter of a driver pressure chamber is preferably of sufficient diameter so as to fill the interior inner diameter of the chamber and prevent fluid leakage at maximum pressures. An inventive piston preferably contains one or more O-rings 118 positioned around the outer circumference of the piston at one end, both ends, or any position therebetween. A piston 114 is preferably attached to a driver length adjustment mechanism 116 such as a hand wheel connected to the piston 114 by a screw or other positional adjustment mechanism. In a preferred embodiment rotational movement of a driver length adjustment mechanism 116 continually or incrementally adjusts the position of the piston 114 within the driver pressure chamber 112. In a preferred embodiment a driver length adjustment mechanism 116 is a rotational mechanism affixed to a hand wheel or other mechanically or electrically driven rotational driver such that rotation of the wheel adjusts the position of the piston within the driver pressure chamber. The driver length adjustment mechanism is optionally a slide, step, or fixed mechanism. Optionally, the driver pressure chamber 112 is fixed in volume as in an embodiment where a piston and driver length adjustment mechanism is absent. Optionally, a gauge is present associated with or attached to, or integral to a driver length adjustment mechanism 116 to provide an operator with a reference as to the position of the piston 114 within the driver pressure chamber 112 and hence a measure of the interior volume of the driver pressure chamber.

A variable length driver assembly 110 is preferably associated with an adjustable diaphragm cutter assembly 120. An adjustable diaphragm cutter assembly 120 is preferably positioned at a first end 104 of a driven section 102. An adjustable diaphragm cutter assembly 120 illustratively includes an assembly holder 122 that is capable of housing a diaphragm cutter 124. The diaphragm cutter 124 is preferably in an adjustable position and maintained by a mechanism such as an adjustment block 126. An adjustment block is illustratively positioned by one or more adjustment bolts 128 or other positional adjustment mechanism. An assembly holder 122 is preferably made of any suitable material to provide rigidity and transfer pressure between the driver portion 100 throughout the driven portion 102 and out the exit aperture 108. Illustrative materials include stainless steel, steel, iron, aluminum, alloys, glass, polymers, or other suitable material. An assembly holder 122 preferably has a cylindrical or other shaped orifice 130 in which to house a diaphragm cutter 124 and permit transfer of the shock wave down the driven section 102. Preferably an orifice 130 is cylindrical to accept a cylindrically shaped outer region of a diaphragm cutter 124. The depth of an orifice 130 within an assembly holder 122 is preferably sufficient to accept the entire length of a diaphragm cutter 124 such that its position within the assembly holder 122 can completely house the cutter 124 below a diaphragm when the adjustable diaphragm cutter assembly 120 is associated with a variable length driver assembly. Preferably, the adjustment mechanism 126, 128 will position a diaphragm cutter 124 so that it rests against, but does not breach a diaphragm until a desired amount of force from pressure in the driver section forces the diaphragm against the diaphragm cutter 124.

A diaphragm cutter 124 is of any shape or design to be operable to pierce a diaphragm upon engagement of a shockwave generator. Illustratively a diaphragm cutter 124 consists of two blades positioned in a crosswise fashion. The resulting ‘X’ configuration presents a rigid cutting surface so as to breach a diaphragm upon engagement of the inventive shockwave generator. The blades of a diaphragm cutter are optionally surgical steel, stainless steel, iron, alloy, polymers, or other material operable herein. A single blade is operable in a diaphragm cutter 124. Optionally three, four, five, six, or more blades are operable in a diaphragm cutter 124.

When an inventive driven section is associated with a driver section, a diaphragm is preferably positioned therebetween. A diaphragm is illustratively made from a material that is breachable by a diaphragm cutter when subjected to pressures present within a driver section. For low-pressure applications, such as applications from 500 to 1,000 kPa, in interior driver fluid pressure, a diaphragm is preferably aluminum For high-pressure applications such as those including an internal fluid pressure of 5,000 kPa or more, a diaphragm is preferably stainless steel. It is appreciated that other materials are similarly operable herein. Illustrative materials operable for a diaphragm include copper, aluminum, stainless steel, and polymers. Stainless steel and aluminum are preferred. In a preferred embodiment a diaphragm has a thickness between 0.01 to 0.5 mm. More preferably the thickness of a diaphragm is between 0.02 and 0.1 mm. More preferably the diaphragm has a thickness of 0.05 mm. It is appreciated that a thicker diaphragm will require more pressure in a driven section to be forced against a stationary diaphragm cutter to breach the diaphragm whereas a thinner diaphragm will be breached with less pressure in the driven section using a stationary diaphragm cutter.

The driven section preferably includes a cylindrical shaft that has an inner diameter and an outer diameter. An inner diameter is preferably between 1 and 34 cm. More preferably the inner diameter is 2.54 cm or alternatively 10.16 cm. It should be noted, however, that the larger the blast tube diameter the more uniform and realistic the blast. The shaft of the driven section is preferably made of materials of sufficient rigidity to resist distortion or other shape change so as to transfer a shock wave through the inner diameter of the driven section and out the exit aperture with a minimal loss or change in fluid pressure. Preferably a driven section is made of similar materials to that of a driver section. The shaft of a driven section is preferably longer than the length of a driver pressure chamber. Preferably the ratio of the length of the driver section to the length of the driven section is between 1:2 and 1:50. Larger inner diameter tubes should have a length at least 10 times the diameter of the tube. Notwithstanding the inner diameter of the driven section, the preferable ratio is 1:15.

The length ratio of driver to driven section is one parameter that determines the peak and duration of the upper pressure event. A driver section preferably has a second end that terminates in an exit aperture. An exit aperture preferably has a diameter that is equal to the inner diameter of the driven section shaft. Optionally the exit aperture is smaller than the inner diameter of the driven section shaft. Optionally the exit aperture is larger than the inner diameter of the driven section. More preferably the diameter of the exit aperture is between 1 and 31 cm. More preferably the exit aperture is 2.54 cm or 10.16 cm. Alternatively, as larger test footprint becomes available, a secondary driven section may be attached between the diaphragm section and the original driven section to allow for blast waves to be formed within the driven section itself.

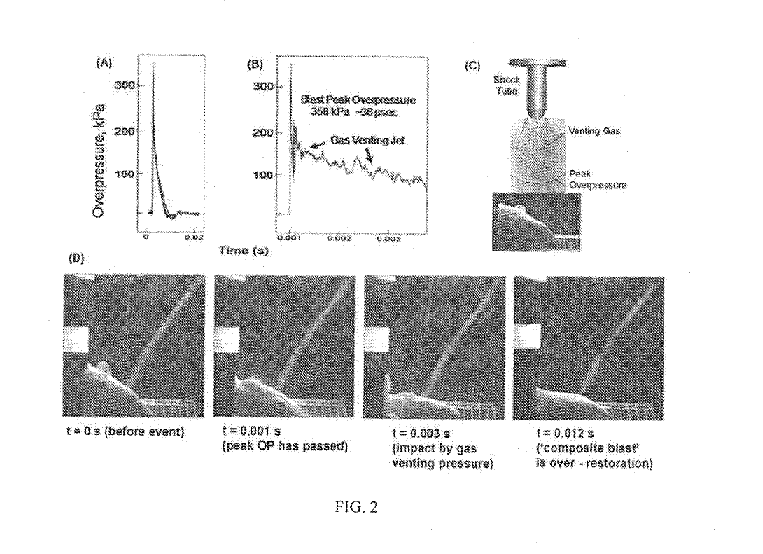

The inner shape of a drive section is preferably circular. It is appreciated that other shapes are operable herein illustratively including oval, square, rectangular, triangular, hexagonical, or other multisided shape. As the shape of the internal surface of the drive section will alter the shape of the resulting wave, a circular shape is preferred. An exit aperture is preferably the terminal end of a tapered driven section as seen in FIG. 2C. The taper at the end of the driven section improves the shape of the shock wave so as not to impede proper blast directionality and shaping. The exit aperture comprises of angular external surface areas to deflect the incidence of reflective shock waves away from the blast region to better replicate consistent blast parameters. The angle of external surface of the exit aperture can be between 0° and 180° however the preferred angle is between 10° and 170° to effectively deflect the incidence of reflective shock waves away from the blast region. Pressure sensors are also used to monitor formation of the shock wave will be located in the driven section A blast wave produced by the inventive shock wave generator is preferably spherically shaped.

An inventive shockwave generator optionally includes a solenoid controlled or other valving mechanism to allow an operator to control when and/or the extent of pressure transferred into the driven section to produce firing of the shockwave generator. A shockwave generator is preferably fired by opening of a valve. The opening of the valve causes fluid to enter the driven section increasing the fluid pressure until the diaphragm is forced against the diaphragm cutter. As such, a diaphragm thickness and material is chosen based on the desired firing pressure to generate a shockwave. The diaphragm being forced against the cutter causes the cutter to breach the diaphragm generating a shockwave. In an alternative embodiment a diaphragm cutter has a triggering mechanism so that it moves to breach a diaphragm after pressure in the driven section has reached a desired value.

An inventive shockwave generator optionally includes one or more transducers positioned at one or more locations within the driven section or the driver section. Preferably a transducer is positioned within 5 cm of the exit aperture in a driven section. More preferably a second transducer is positioned within 55 cm of the exit aperture of a driven section. The multiple transducers allow measurement of a pressure wave as it moves through the driven section and exits the exit aperture during operation of the shockwave generator. It is appreciated that a driven section may be made of more than one shaft connected so as to form a single linear, curved, or other shaped inner chamber. In a preferred embodiment a driven section is a linear shaft. A driven section, parts of a driven section, or parts of a shaft are preferably interconnected by one or more bolts or other fastening means. For high-pressure applications a driven section is preferably associated with a driver section by one or more bolts. High-pressure applications are illustratively pressures within a driver section in excess of 1,000 kPa. A low-pressure application includes applications of the shockwave generator at internal driver pressures of less than 1,000 kPa. Under such low-pressure operation conditions, a driven section and a driver section are optionally associated by one or more clamps to facilitate easy removal and resetting of the system.

A shockwave generator preferably includes a support base designed to hold the shock tube in place. The support base allows for placement of pressure transducers to provide accurate and repeatable characterization of the pressure field of the outgoing blast wave. The preferred embodiment of the support structure includes a rectangular frame and be constructed such that it provides portability and ease of operation in a horizontal position

A shockwave generator preferably uses fluid pressure to create a shockwave that transfers through a driven section and out the exit aperture. Preferably a fluid is air; it is appreciated that fluids operable herein are optionally helium, nitrogen, oxygen, or other gas, or fluids illustratively including water. A fluid is preferably purified.

An inventive shockwave generator preferably includes one or more valves to allow release of pressure under either emergency or other desired condition. One or more hoses optionally connect a fluid pressure system with an inventive shockwave generator.

### Sensor Platform

The explosion of a conventional bomb generates a blast wave that spreads out spherically from the origin of the explosion. Both the overpressure and time duration of the blast event decrease exponentially with a distance from the origin of the explosion. Although the physics of blast waves are complex and nonlinear, a blast wave may be broadly characterized by its peak overpressure and the duration of the positive phase of the over pressure event. The controlled shockwave generator described provides the methodology to create sub-scale repeatable blast events. Peak overpressure, duration and transmitted impulse can be controlled to replicate pressure blast events scaled to an equivalent amount of TNT, as function of the distance to the blast source.

A novel instrumentation and data acquisition platform has been invented that will enable simultaneous acquisition of pressure, acceleration and rate of rotation at multiple points within the specimen on an unconstrained live target, while minimally affecting the interaction between the oncoming blast pressure wave and the test specimen. Furthermore the sensor platform allows for the data recording of cumulative blast sensor data to solid-state memory, and untethered operation. These objectives are achieved by a microprocessor-based data acquisition and storage design that incorporates state-of-the-art miniature sensors, solid-state memory and compact lightweight power supply, preferably a battery, being therefore small enough to be attached to a user or test platform without need of external wiring.

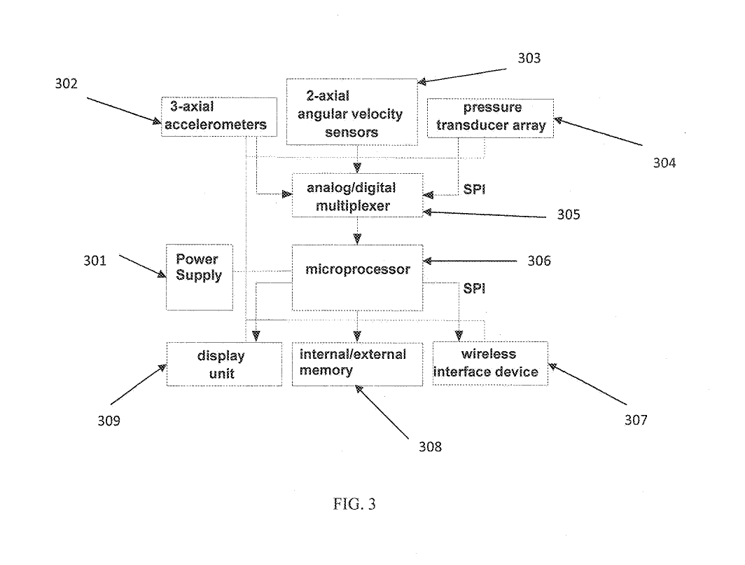

The sensor platform (FIG. 3) illustratively includes a power supply 301 connected to at least 3-axial accelerometers 302, at least 2-axial angular velocity sensors 303, a pressure transducer array 304, an analog/digital multiplexer 305, a microprocessor 306, a wireless interface 307, and a display unit 309. The power supply 301 is preferably a lithium ion battery pack, or may be some other portable or fixed power source. It is further preferred that the power supply be small, lightweight and capable of supplying power to the sensor platform for an extended period of time without recharging.

Currently MEMS IC technology is preferred to be used in the sensor platform, specifically for the 3-axial accelerometers 302 and the 2-axial or 3-axial angular velocity sensors 303 to provide a cost-effective ultra-light instrumentation package to capture and record cumulative exposure to multiple blast events, peak blast overpressure, force, and multi-axis acceleration (X, Y and Z), impulse and rate of rotation. However, other sensor technologies that measure similar parameters of blast events may be used. The use of MEMS sensors on wearable wireless devices for biomedical testing is a novel trend that takes advantage of the most recent advances in MEMS, microprocessors, miniature electronic packaging and wireless technologies. Accelerometers and angular velocity sensors (gyros) are used to measure several parameters, including, but not limited to, exposure to impulse and angular acceleration. Additionally, a pressure transducer array 304, comprising of at least one pressure sensor is used to measure peak pressure and cumulative exposure to blast waves.

An analog/digital multiplexer 305 may be used in conjunction with a microprocessor 306 for A/D conversion, signal interfacing, data recording and storage, display and/or real-time communication. After a blast event, the data is then transmitted through a wireless interface 307, stored in internal/external memory location 308 and/or displayed on a display unit 309. The preferred method for internal/external memory is for the collected data to be stored on such as SD cards or other flash memory device. The data is also available at a remote location in real time using a wireless communication device.

The sensor platform may also be embedded or affixed on blast protection devices such as helmets or vests to record cumulative blast exposure, and may be used to correlate the blast data to models of blast-induced injury. Alternatively the sensor platform may be used to measure the effectiveness or efficiency of a device or material to dampen, shield, or otherwise reduce the effects of blast injury in a blast environment. The device is intended to be light-weight and cost effective as well as provide a real-time display and/or wireless transmission to a remote location. Additionally, quantitative correlations between exposures to cumulative blast events are used to predict injury types and severity which will be readable either from the internal/external memory, the display unit or the remote location receiving the data from the wireless interface device for helping medical triage of blast casualties. It is further contemplated that cumulative blast data may be used to compile a blast exposure profile for a specific individual to establish a set of guidelines to determine battle readiness and be used to profile personnel when contemplating future combat mission or duties.

All analog measurements (cumulative exposure to blasts waves, peak blast overpressure, force, acceleration, and rate of rotation) are acquired simultaneously or synchronously during target exposure to blast, and later stored locally to SD memory. Exposure data can be separately recorded for pressure blasts coming from different directions, providing valuable information to field medical personnel to assess potential injuries.

In the pressure sensor package, the sensing element consists of a silicon wafer that is locally thinned to form a pressure sensitive diaphragm. The diaphragm acts as a movable plate on a capacitive sensor. The stationary plate is a thin film metal deposited on a second, glass coated silicon wafer. The wafers are joined by anodic bonding so that a hermetically enclosed space is formed between them. The diaphragm deflects due to the pressure difference between the exterior of the sensor and the internal vacuum reference chamber.

Packaging effects, acoustic behavior and other environmental factors must be taken into account when using MEMS accelerometers, pressure transducers and angular rate sensors. The angular rate sensor uses two sensor elements with a vibrating dual-mass bulk silicon configuration to sense the rate of rotation about the X-, Y- and/or Z-axis (in-plane sensing). All required electronics are integrated onto a single chip with the sensor. Modern signal processing methods can be used with this type of sensor to enhance its performance.

The inventive sensor platform also includes a novel instrumentation and high performance data acquisition platform that enables simultaneous acquisition of pressure, acceleration and rate of rotation at multiple points within the specimen on an unconstrained live target, while minimally affecting the interaction between the oncoming blast pressure wave and the test specimen. The data acquisition system further comprises a means for data recording of cumulative blast sensor data to solid-state memory, and untethered operation, such as a wireless communication link. The system is used for simultaneous monitoring of pressure waves both inside the shock tube and at selected locations within the pressure field. The system comprises of a data acquisition system chassis, at least one data acquisition device, a data communication between the data acquisition system and a remote data collector, and low noise sub miniature terminal blocks. In one embodiment the system comprises a National Instruments PXI chassis, two four-channel simultaneous sampling high-rate data acquisition cards, synchronized at the PXI backplane, a data communication link to a host PC, and low noise sub-miniature terminal blocks. The data acquisition system is used for mapping and calibration of the shock tube's workspace and allows truly simultaneous acquisition of up to eight channels at any speed, preferably at least 10 M samples/sec/channel based on independent analog to digital converters.

### Injury Metric

Injury type and severity is assessed using organ-specific proprietary biomarkers which correlates to the recorded cumulative blast and will aide in the diagnosis of neuronal injury and the administration of therapeutics, treatments and other injury preventative measures. A brain injury is optionally a traumatic brain injury or a mild brain injury. The inventive shock wave generator produces blast forces that are sufficiently repeatable so as to produce replicate injury magnitudes of adjustable force and the cumulative blast sensors provide a mode of correlating the blast forces to injury. The inventive system is particularly suited to experimental infliction of brain injury to a subject; however injury to the body as a whole, both internally and externally, is also possible. Additionally the inventive system will also be used to predict Post Traumatic Stress Disorder and post-combat suicidal tendencies by correlating cumulative blast exposure to biomarkers known to correlate with subjects who are likely to exhibit those conditions.

A subject as defined herein is optionally a mammal Preferably, a subject is a primate including higher and lower primates including humans. Preferably, a subject is a rodent. A rodent illustratively includes a rat or mouse. Other subjects illustratively include a hamster, guinea pig, rabbit, pig, horse, sheep, bovine, donkey, dog, or cat.

Several biomarkers of neuronal injury are optionally studied with the inventive shock wave generator. Inventive neuroactive biomarkers illustratively include GFAP, neuron specific enolase (NSE), ubiquitin C-terminal hydrolase L1 (UCHL1), Spectrin Breakdown Products (SBDP), S-100B, Neuronal Nuclei protein (NeuN), 2′,3′-cyclic nucleotide 3′-phosphodiesterase (CNPase), p11 protein and mRNA, Soluble Intercellular Adhesion Molecule-1 (sICAM-1), myelin basic protein, and inducible nitric oxide synthase (iNOS). More preferably an inventive neuroactive biomarker is CNPase. Neuron specific enolase (NSE) is found primarily in neurons. GFAP is found only in. Schwann cells. CNPas is found in the myelin of the central nervous system.

CNPase is a marker of oligodendrocyte lineage developing into Schwann cells producing myelin. CNPase is inventively observed in statistically significant increased levels following blast injury. The greatest levels of CNPase are observed between 1 hour and 30 days following blast injury, particularly in the hippocampus. The levels of CNPase may increase over the first 30 days following injury suggesting an increase in Schwann cell development or myelin production. Following fluid percussion injury levels of CNPase co localized with BrdU positive cells. Urrea, C. et al., Restorative Neurology and Neuroscience, 2007; 25:6576. CNPase is preferably used as a neuroactive biomarker of Schwann cell development from oligodendrocytes. Alterations in the levels of CNPase in particular neuronal tissues such as the hippocampus is indicative of neuronal changes that signal an effect of a screened drug candidate or as a safety or efficacy measure of chemical compound or other therapy effect.

CNPase is preferably used as a marker for safety and efficacy screening for drug candidates. Illustratively, CNPase is operable as a marker of the protective, regenerative or disruption effects of test compounds. Optionally, drug screening is performed in vitro. CNPase levels are determined before, after, or during test compound or control administration to Schwann cells cultured alone or as a component of a co-culture system. Illustratively, Schwann cells are co-cultured with sensory neuronal cells, muscle cells, or glial cells such as astrocytes or oligodendrocyte precursor cells.

In vivo screening or assay protocols illustratively include measurement of a neuroactive biomarker in an animal either after being subjected to shock wave injury by the inventive shock wave generator or in a control group illustratively including a mouse, rat, or human. Studies to determine or monitor levels of neuroactive biomarker levels such as GFAP following blast injury with an inventive shock wave generator are optionally combined with behavioral analyses or motor deficit analyses such as: motor coordination tests illustratively including Rotarod, beam walk test, gait analysis, grid test, hanging test and string test; sedation tests illustratively including those detecting spontaneous loco motor activity in the open-field test; sensitivity tests for allodynia—cold bath tests, hot plate tests at 38° C. and Von Frey tests; sensitivity tests for hyperalgesia—hot plate tests at 52° C. and Randall-Sellito tests; and EMG evaluations such as sensory and motor nerve conduction, Compound Muscle Action Potential (CMAP) and h-wave reflex.

As GFAP is associated with glial cells such as astrocytes, preferably the other biomarker is associated with the health of a different type of cell associated with neural function. More preferably, the other cell type is an axon, neuron, or dendrite. A synergistic measurement of GFAP optionally along with at least one additional neuroactive biomarker and comparing the quantity of GFAP and the additional biomarker following blast injury with an inventive shock wave generator to normal levels of the markers provides a determination of subject neurological condition before or after shock wave injury. Specific biomarker levels that when measured in concert with GFAP afford superior evaluation of subject neurological condition illustratively include SBDP145 (calpain mediated acute neural necrosis), SBDP120 (caspase mediated delayed neural apoptosis), UCH-L1 (neuronal cell body damage marker), S-100B, and MAP-2.

An analysis of an inventive blast injury to a subject with the inventive shock wave generator produces several inventive correlations between proteins and neuronal injury. Neuronal injury is optionally the result of whole body blast, blast force to a particular portion of the body, or the result of other neuronal trauma or disease that produces detectable or differentiable levels of neuroactive biomarkers. Thus, identifying pathogenic pathways of primary blast brain injury (BBI) in reproducible experimental models is vital to the development of diagnostic algorithms for differentiating severe, moderate and mild (mTBI) from posttraumatic stress disorder (PTSD). Accordingly, a number of experimental animal models are operable with the inventive shock wave generator to study mechanisms of shock wave impact and include rodents and larger animals such as sheep.

Following shock wave injury, and to provide correlations between neurological condition and measured quantities of GFAP and other neuroactive biomarkers, samples of CSF or serum are collected from subjects with the samples being subjected to measurement of GFAP as well as other neuroactive biomarkers. The subjects vary in neurological condition. Detected levels of GFAP and other neuroactive biomarkers are then optionally correlated with CT scan results as well as GCS scoring.

It is appreciated that GFAP and other neuroactive biomarkers, in addition to being obtained from CSF and serum, are also readily obtained from blood, plasma, saliva, urine, as well as solid tissue biopsy. While CSF is a preferred sampling fluid owing to direct contact with the nervous system, it is appreciated that other biological fluids have advantages in being sampled for other purposes and therefore allow determination of neurological condition as part of a battery of tests performed on a single sample such as blood, plasma, serum, saliva or urine.

A biological sample is obtained from a subject by conventional techniques. For example, CSF is preferably obtained by lumbar puncture. Blood is obtained by venipuncture, while plasma and serum are obtained by fractionating whole blood according to known methods. Surgical techniques for obtaining solid tissue samples are well known in the art. For example, methods for obtaining a nervous system tissue sample are described in standard neurosurgery texts such as Atlas of Neurosurgery: Basic Approaches to Cranial and Vascular Procedures, by F. Meyer, Churchill Livingstone, 1999; Stereotactic and Image Directed Surgery of Brain Tumors, 1st ed., by David G. T. Thomas, WB Saunders Co., 1993; and Cranial Microsurgery: Approaches and Techniques, by L. N. Sekhar and E. De Oliveira, 1st ed., Thieme Medical Publishing, 1999. Methods for obtaining and analyzing brain tissue are also described in Belay et al., Arch. Neural. 58: 1673-1678 (2001); and Seijo et al., J. Clin. Microbiol. 38: 3892-3895 (2000).

Any subject that expresses GFAP or other biomarker illustratively includes a dog, a cat, a horse, a cow, a pig, a sheep, a goat, a chicken, non-human primate, a human, a rat, and a mouse.

An exemplary process for detecting the presence or absence of GFAP or another biomarker in a biological sample involves subjecting a subject to a shock wave from an inventive shock wave generator, obtaining a biological sample from a subject, contacting the biological sample with a compound or an agent capable of detecting of the marker being analyzed, illustratively including an antibody or aptamer, and analyzing binding of the compound or agent to the sample. Those samples having specifically bound compound or agent express of the marker being analyzed.

An inventive process can be used to detect GFAP or other neuroactive biomarkers in a biological sample in vitro, as well as in vivo. The quantity of expression of neuroactive biomarkers in a sample subjected to shock wave injury is compared with appropriate controls such as a first sample known to express detectable levels of the marker being analyzed (positive control) and a second sample known to not express detectable levels of the marker being analyzed (a negative control). For example, in vitro techniques for detection of a marker include enzyme linked immunosorbent assays (ELISAs), Western blots, immunoprecipitations and immunofluorescence. Furthermore, in vivo techniques for detection of a marker include introducing a labeled agent that specifically binds the marker into a biological sample or test subject. For example, the agent is optionally labeled with a radioactive marker whose presence and location in a biological sample or test subject can be detected by standard imaging techniques.

Any suitable molecule that can specifically binds one or more neuroactive biomarkers are operative in the invention. A preferred agent for detecting a neuroactive biomarker is an antibody capable of binding to the biomarker being analyzed; preferably an antibody is conjugated with a detectable label. Such antibodies are optionally polyclonal or monoclonal. An intact antibody, a fragment thereof (e.g., Fab or F(ab′)₂), or an engineered variant thereof (e.g., sFv) is optionally used. Such antibodies are of any immunoglobulin class including IgG, IgM, IgE, IgA, IgD and any subclass thereof.

Antibody-based assays are preferred for analyzing a biological sample for the presence of neuroactive biomarkers. For more rapid analysis immunosorbent assays (e.g., ELISA and RIA) and immunoprecipitation assays are optionally used. As one example, the biological sample or a portion thereof is immobilized on a substrate, such as a membrane made of nitrocellulose or PVDF; or a rigid substrate made of polystyrene or other plastic polymer such as a microtiter plate, and the substrate is contacted with an antibody that specifically bind a neuroactive biomarker under conditions that allow binding of antibody to the biomarker being analyzed. After washing, the presence of the antibody on the substrate indicates that the sample contained the marker being assessed. If the antibody is directly conjugated with a detectable label, such as an enzyme, fluorophore, or radioisotope, the label presence is optionally detected by examining the substrate for the detectable label. Alternatively, a detectably labeled secondary antibody that binds the marker-specific antibody is added to the substrate. The presence of detectable label on the substrate after washing indicates that the sample contained the marker.

Numerous permutations of these basic immunoassays are also operative for use in conjunction with the inventive shock wave generator. These include the biomarker-specific antibody, as opposed to the sample being immobilized on a substrate, and the substrate is contacted with neuroactive biomarker conjugated to a detectable label under conditions that cause binding of antibody to the labeled marker. The substrate is then contacted with a sample under conditions that allow binding of the marker being analyzed to the antibody. A reduction in the amount of detectable label on the substrate after washing indicates that the sample contained the marker.

Although antibodies are preferred for use in the invention because of their extensive characterization, any other suitable agent (e.g., a peptide, an aptamer, or a small organic molecule) that specifically binds a neuroactive biomarker is optionally used in place of the antibody in immunoassays. For example, an aptamer that specifically binds all spectrin and/or one or more of its SBDPs is optionally used. Aptamers are nucleic acid-based molecules that bind specific ligands. Methods for making aptamers with a particular binding specificity are known as detailed in U.S. Pat. Nos. 5,475,096; 5,670,637; 5,696,249; 5,270,163; 5,707,796; 5,595,877; 5,660,985; 5,567,588; 5,683,867; 5,637,459; and 6,011,020.

A myriad of detectable labels known in the art are operative in a diagnostic assay for biomarker expression. Agents used in methods for detecting a neuroactive biomarker are conjugated to a detectable label, e.g., an enzyme such as horseradish peroxidase. Agents labeled with horseradish peroxidase are optionally detected by adding an appropriate substrate that produces a color change in the presence of horseradish peroxidase. Several other detectable labels operable herein are known. Common examples include alkaline phosphatase, horseradish peroxidase, fluorescent compounds, luminescent compounds, colloidal gold, magnetic particles, biotin, radioisotopes, and other enzymes.

The present invention is optionally used to correlate the presence or amount of GFAP or other neuroactive biomarker in a biological sample with the severity and/or type of nerve cell injury. The amount of GFAP or other neuroactive biomarker in the biological sample is associated with neurological condition for traumatic brain injury as detailed in the Examples.

Various aspects of the present invention are illustrated by the following non-limiting examples. The examples are for illustrative purposes and are not a limitation on any practice of the present invention. It will be understood that variations and modifications can be made without departing from the spirit and scope of the invention. While the examples are generally directed to mammalian tissue, specifically, analyses of murine tissue, a person having ordinary skill in the art recognizes that similar techniques and other techniques known in the art readily translate the examples to other organisms such as humans. Reagents illustrated herein are commonly cross reactive between mammalian species or alternative reagents with similar properties are commercially available, and a person of ordinary skill in the art readily understands where such reagents may be obtained.

### Example 1

### Shock Wave Generator Construction and Setup

A compressed air-driven shock tube is used to expose rats to a supra-atmospheric wave of air pressure. A shock tube capable of generating a wide range of controlled blast waves without the use of explosives is designed, constructed and tested at both the Florida Institute of Technology and Banyan Biomarkers, Inc. (FIG. 1A). The tube is separated in two sections, high pressure (driver) and low-pressure (driven), separated by a metal diaphragm. The thickness, type of material, driver/driven ratio, and the initial driver pressure determines the peak and duration of the overpressure event. In the presented series of experiments, 0.05 mm thick stainless steel diaphragms are used to generate high pressure shockwaves. The ratio of driver vs. driven section lengths is 15 to 1. The driver section is initialized to a pressure of 5,170 kPa and the driven section is left at ambient pressure. The diaphragm rupture by an internal cutter leads to the sudden exposure of a low pressure air to gas at significantly higher pressure, resulting in the formation of a shock wave. The blast pressure data is acquired using the sensor platform and integrated data acquisition hardware and software. The shock tube including the driver section and the driven section is calibrated so that the peak overpressure indicates the actual measures (kPa) at the surface of the rat's skull. Images of the rat head during the blast event are captured at 1,000 frames/sec using a high speed video camera and Schlieren optics.

The shock tube (FIG. 1) is designed and built to model a freely expanding blast wave as generated by a typical explosion. Preliminary tests are conducted with no subjects to map the pressure field, and optimize settings to produce desired levels of peak overpressure (OP) and exposure time to accurately reproduce blast events. Several parameters are adjusted including driver pressure and volume, diaphragm material, and shock tube exit geometry. Following the diaphragm rupture, the driver gas sets up a series of pressure waves in the low pressure driven section that coalesce to form the incident shockwave (FIG. 2A, B). Both static and dynamic (total) pressure is measured using piezoelectric blast pressure sensors/transducers positioned at the target. The shockwave recorded by blast pressure transducers in the driven section and at the target show three distinct events: (i) peak overpressure; (ii) gas venting jet; and (iii) negative pressure phase. Peak overpressure, positive phase duration, and impulse appear to be the key parameters that correlate to injury and likelihood of fatality in animals and humans, for various orientations of the specimen relative to the blast wave. A schematic of a shock tube nozzle and the rat location relative to the shock tube axis, blast overpressure wave and gas venting cone is shown in FIG. 2C.

### Example 2

### Animal Exposure to Composite Blast

Rats are anesthetized with 3-5% isoflurane in a carrier gas of oxygen using an induction chamber. At the loss of toe pinch reflex, the anesthetic flow is reduced to 1-3%. A nose cone continues to deliver the anesthetic gases. Isoflurane anesthetized rats are placed into a sterotaxic holder exposing only their head (body-armored setup) or in a holder allowing both head and body exposure. The head is allowed to move freely along the longitudinal axis and placed at the distance 5 cm from the exit nozzle of the shock tube, which is positioned perpendicular to the middle of the head (FIG. 2). The head is laid on a flexible mesh surface composed of a thin steel grating to minimize reflection of blast waves and formation of secondary waves that would potentially exacerbate the injury.

The rat may be placed directly under the venting cone (FIG. 2C) or be placed off-axis of the nozzle center. For more uniform results and a realistic shock profile, the preferred position of the placement is off-axis from the venting cone since it will expose the rat to a pure peak overpressure primary blast and avoid the venting fluid impact which may cause secondary injury not typical of a representative shock blast

For pathomorphology and biomarker studies, animals are subjected to a single blast wave with a mean peak overpressure of 358 kPa at the head, and a total positive pressure phase duration of approximately 10 msec (FIG. 2). This impact produces a non-lethal, yet strong effect. (Table 1).

TABLE 1

| | | |
|---|---|---|
| Peak Overpressure | Total Blast | |
| (kPa) | Duration (msec) | Mortality |

Total exposure (unprotected body)

| | | |
|---|---|---|
| 110 | 2 | survived |
| (n = 3) | | |
| 170 | 4 | lethal |
| (n = 2) | | |
| 358 | 1 | lethal |
| (n = 2) | | |

Head-directed (body armored)

| | | |
|---|---|---|
| 172 | 4 | all survived |
| (n = 12) | | |
| 358 | 10 | all but one survived |
| (n = 48) | | |

For survival studies, body-armored rats are also exposed to head-directed blast of 172 kPa for a total duration of 4 msec. In addition, survival/mortality is investigated in rats exposed to head directed blast of different magnitude/duration without body protection as shown in Table 1. Sham and naïve control animal groups are subjected to the same treatment (anesthesia, handling, recovery) except not exposed to blast. The rats in a sham group are exposed to the noise of a single blast at 2 m from the shock tube while anesthetized.

After exposure of anesthetized rats with unprotected body to blast of 110 kPa (total peak overpressure, OP) for 2 msec of composite blast wave, all rats remain alive during the initial period of 24-48 hours post-blast (Table 1). Transitory symptoms of agitation are observed within 15 to 30 min after exposure during recovery from anesthesia. Increasing blast OP magnitude to 170 kPa or 358 kPa for total blast duration of 4 and 1 msec, respectively, produces increased rat mortality immediately after blast exposure. By contrast, protecting the body in the holder significantly increases threshold of mortality, and all rats are alive after severe blast of 358 kPa peak OP and total duration of ˜10 msec (Table 1). FIG. 2D depicts rat head deformation recorded by high speed video upon this severe head-directed blast wave exposure for 10 msec. Due to the complex nature of the blast event the brain injury is a result of a combined impact of the “composite” blast including all 3 major phases of a shockwave shown in FIGS. 2A and B. Gas venting jet, albeit lower in magnitude, lasts the longest, represents the bulk of blast impulse and, possibly produces the most devastating impact. A strong downward head acceleration is observed following the passage of peak overpressure which lasts ˜36 μsec (FIG. 2D). Under these conditions cranial deformation is more severe during the gas venting phase, lasting up to ˜10 msec. Only when the positive pressure phase is over does the shape of the rat's skull begin to restore to pre-blast conformation.

### Example 3

### Cumulative Blast Exposure and Measurement

A rat is exposed in the morning to a blast of approximately 10-15 psi (whole body), then repeated three or four times with 1 hour interval. One hour after last exposure, the cumulative sensor platform has recorded cumulative pressure received by the rat, magnitude, duration and impulse transferred, and time between exposures. Data is downloaded at the end of each blast test and additionally the cumulative data is also collected after the completion of the last blast exposure. The data collected is loaded into data analysis software for post processing, analysis and plotting allowing direct access to all sensor data acquired during the test. Metrics such as impulse and cumulative blast exposure can be calculated from the collected files. The data is then correlated with a table of exposure blast and its corresponding measurement of injury to the rat. The injury metric may be used to predict brain injury or other bodily injury associated with explosive blast shock to the animal.

Data may be used to design, assist in design, or test blast protective gear, such as helmets, vests, or any type of blast dampening device.

### Example 4

During operation of the data acquisition system, the main board is started using an external trigger, which could be a manual TTL signal that also starts the PXI-based data acquisition system that records the blast event. The main board is preprogrammed to acquire a set number of samples at a fixed sampling rate. The use of external independent analog to digital converters enables simultaneous data acquisition of all pressure sensors placed on the test specimen. During sampling, the data is stored to the external SD card in a raw unreadable format to reduce data collection overhead and allow high speed sampling. Once the board has completed acquiring the desired number of samples, the file is read back and converted to a human readable tab delimited text file. Such format can be easily read and post processed using Matlab or any other data processing software. The second board (IMU Slave) is a standalone inertial measurement unit (IMU) that includes a tri-axial analog accelerometer, tri-axial analog gyroscopic sensor, and tri-axial digital compass. Operation of the Slave board is controlled by its own CPU, externally triggered by the Main board.

This design allows uninterrupted IMU data streaming, which can be logged to its own SD memory card. The Slave board uses the PIC24HJ's built-in ADC module, multiplexed to both the tri-axial accelerometer as well as the tri-axial gyro (6 analog input channels). Once the IMU (Slave) board is triggered by the Main board, it collects data from all its analog sensors at a set sampling rate, and appends them to a text file created on the SD card when the trigger pulse is received for the first time. The board can also be turned off by the same trigger used to activate it. In addition to the accelerometers and gyroscopic sensors, the IMU board also contains a three axis digital compass. This compass is used to correct gyro drift during post processing. This compass uses a digital SPI interface and the data is also logged to the end of the file. A similar data collection sequence as the one described above is used to enable faster sampling rates.

### Example 5

### Histological Study of Blast Effect

Fresh Tissue Collection: At the required time points following blast exposure, animals are euthanized according to guidelines approved by the IACUC of the University of Florida. Tissue samples are collected, snap-frozen, and stored at −70° C. until further analysis. A dorsal midline incision is made over the cervical vertebrae and occiput. The atlanto-occipital membrane is exposed by blunt dissection. CSF is collected by lowering a 25 gauge needle attached to polyethylene tubing into the cisterna magna. Immediately following CSF collection, the rat is turned over. The chest cavity is opened and 3-6 ml of blood is withdrawn by cardiac puncture. Following blood collection, the animal is removed from the stereotaxic frame and immediately decapitated (while still under the effects of the anesthesia gases) for fresh brain tissue collection.

Neurodegeneration in injured brains is examined by the de Olmos aminocupric silver histochemical technique. At the intended time of sacrifice, rats are deeply anesthetized with sodium pentobarbital (100 mg/kg I.P.) and transcardially perfused with 0.8% NaCl, 0.4% Dextrose, 0.8% Sucrose, 0.023% CaCl₂ and 0.034% Sodium Cacodylate, followed by a fixative solution containing 4% Paraformaldehyde, 4% Sucrose and 1.4% Sodium Cacodylate. Following decapitation, the heads are stored in the perfusion fix for 14 h, after which the brains are removed, placed in Cacodylate storage buffer, and processed for histological analyses (Neuroscience Associates, Inc., Knoxville, Tenn.). Frozen 35-μ-thick coronal sections, taken 420 μm apart between 1.1 mm anterior and 4.4 mm posterior to bregma, are silver stained for neuronal degeneration and counter-stained with Neutral Red. The brain sections are scanned at high resolution.

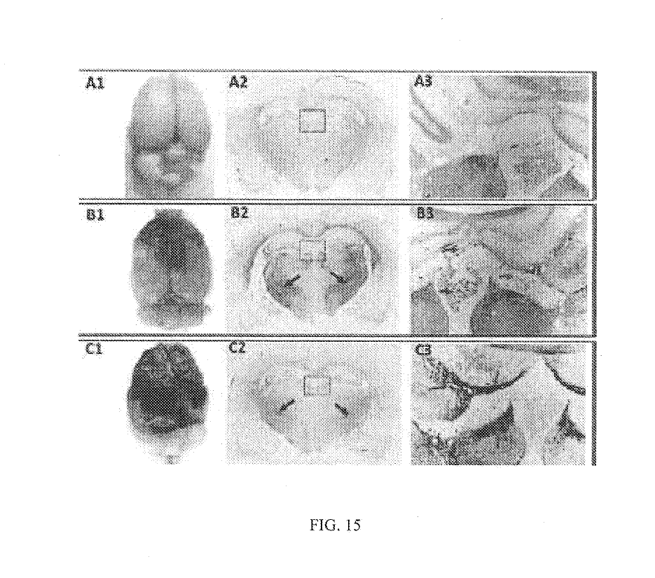

Head acceleration and deformation after severe blast exposure is accompanied by typical focal and massive intracranial hematomas and brain swelling (FIGS. 15 B1 and C1). The hemorrhages and hematomas develop within hours after impact and are visualized through the undamaged scull at 24 to 48 hours after blast exposure. The size of hematomas varies significantly in different rats and forms a capsule at 5 day post-blast (FIG. 15 C1). The intracranial blood accumulation partially resolved at day 14 in a majority of rats observed.

Coronal brain sections are fixed in situ by transcardial perfusion and stained for neurodegeneration using silver impregnation. Prominent silver staining is observed at 48 h post-blast in the deep brain areas such as Caudal Diencephalon including nucleus subthalamicus zone (FIGS. 15 B2 and C2). The patterns of staining throughout the brain indicate both diffused and focal mild neurodegeneration, predominantly in the deep areas of rostral and caudaldiencephalon (FIGS. 15B and C) and mesencephalon. Particularly, brain histochemistry indicates a prominent silver accumulation in perivascular spaces and subventricular zones at 48 h and predominant tissue localization 5 days post-blast (FIGS. 15 B3 and C3).

### Example 6

Biomarker levels in rat tissue following blast wave exposure. For Analyses of CNPase and GFAP levels in rat tissues, Western blotting is performed on brain tissue samples homogenized on ice in Western blot buffer as described previously in detail by Ringger N C, et al., J Neurotrauma, 2004; 21:1443-1456, the contents of which are incorporated herein by reference. Samples are subjected to SDS-polyacrylamide gel electrophoresis and electroblotted onto PVDF membranes. Membranes are blocked in 10 mM Tris, pH 7.5, 100 mM NaCl, and 0.1% Tween-20 containing 5% nonfat dry milk for 60 min at room temperature. Anti-biomarker specific rabbit polyclonal and monoclonal antibodies are produced in the laboratory for use as primary antibodies. After overnight incubation with primary antibodies (1:2,000), proteins are detected using a goat anti-rabbit antibody conjugated to alkaline phosphatase (ALP) (1:10,000-15,000), followed by colorimetric detection system. Bands of interest are normalized by comparison to β-actin expression used as a loading control.

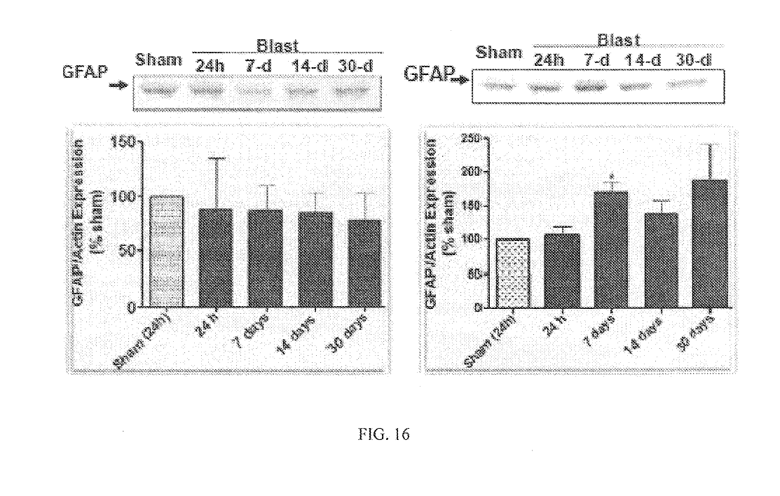

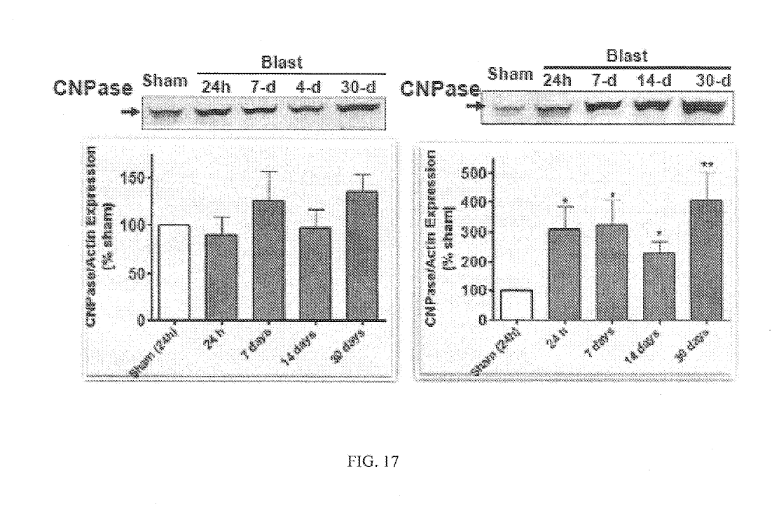

Severe blast exposure in the rat cortex demonstrated no significant increase of GFAP (FIG. 16A), in contrast to a significant GFAP accumulation in hippocampus (FIG. 16B). GFAP levels peak in hippocampus at 7 day after injury and persist up-to 30 day post blast (FIG. 16B). By contrast, CNPase accumulates significantly in the cortex between 7 and 30 days post-blast (FIG. 17A). The most prominent increase in CNPase expression is found in hippocampus demonstrating a nearly four-fold increase at 30 day after blast exposure (FIG. 17B).

Quantitative detection of GFAP and ubiquitin C-terminal hydrolase L1 (UCH-L1) in blood and CSF is determined by commercial sandwich ELISA. UCH-L1 levels are determined using a sandwich ELISA kit from Banyan Biomarkers, Inc. For quantification of glial fibrillary acid protein (GFAP), and neuron specific enolase (NSE) sandwich ELISA kits from BioVendor (Candler, N.C.) are used according to the manufacturer's instructions.

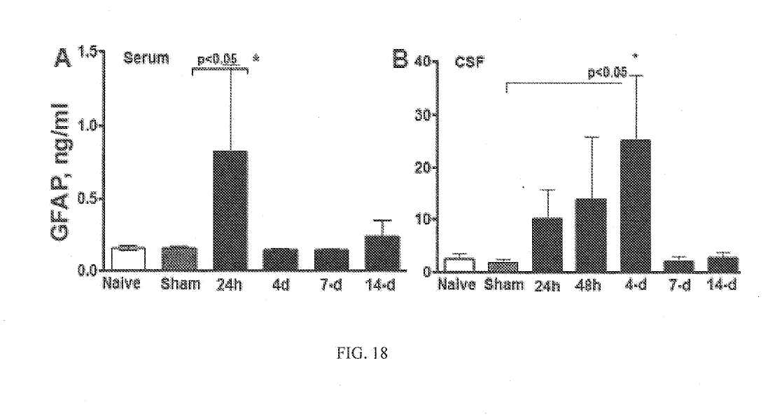

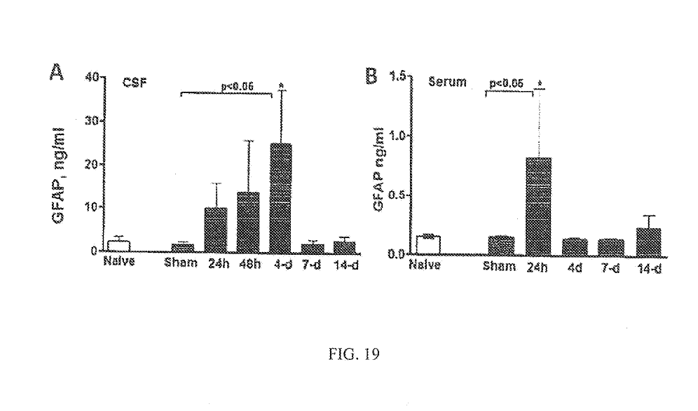

Increase of GFAP expression in brain (hippocampus) is accompanied by rapid and statistically significant accumulation in serum 24 h after injury followed by a decline thereafter (FIG. 18A). GFAP accumulation in CSF is delayed and occurs more gradually, in a time-dependent fashion (FIG. 18B). NSE concentrations are significantly higher at 24 and 48 hours post-blast period in exposed rats compared to naïve control animals (FIG. 19).

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

Methods involving conventional biological techniques are described herein. Such techniques are generally known in the art and are described in detail in methodology treatises such as Molecular Cloning: A Laboratory Manual, 2nd ed., vol. 1-3, ed. Sambrook et al., Cold Spring Harbor Laboratory Press, Cold Spring Harbor, N.Y., 1989; and Current Protocols in Molecular Biology, ed. Ausubel et al., Greene Publishing and Wiley-Interscience, New York, 1992 (with periodic updates). Immunological methods (e.g., preparation of antigen-specific antibodies, immunoprecipitation, and immunoblotting) are described, e.g., in Current Protocols in Immunology, ed. Coligan et al., John Wiley & Sons, New York, 1991; and Methods of Immunological Analysis, ed. Masseyeff et al., John Wiley & Sons, New York, 1992.

The foregoing description is illustrative of particular embodiments of the invention, but is not meant to be a limitation upon the practice thereof. The following claims, including all equivalents thereof, are intended to define the scope of the invention.

1. A process of generating and measuring blast shock comprising:
exposing a shock model to an output of a shockwave generator;
sensing propagation of the output with a portable sensor platform to generate for data acquisitions and storage of wave propagation data;
analyzing the data recorded by the sensor platform to measure the blast shock; and
optionally relating the blast shock alone or as a component of a cumulative blast exposure to an injury metric.

2. The process of claim 1 wherein the shockwave generator further comprises:
a fluid pressure system connected to a driver section connected to a driven section, having an adjustable diaphragm cutter assembly and a diaphragm disposed therebetween, said driver section having an internal pressure greater than said driven section;
said driver section further comprising a variable length driver (VLD) assembly having a bottom end and a high pressure fluid input connection, said VLD assembly comprising a driver pressure chamber and a driver length adjuster whereby a piston is movably positioned within said driver pressure chamber;
said diaphragm cutter assembly having an upper end and a lower end wherein said bottom end of said VLD assembly is connected to said upper end of said diaphragm cutter assembly with said diaphragm disposed therebetween, said diaphragm cutter assembly comprising an assembly holder, a diaphragm cutter movably positioned within said diaphragm cutter assembly; and an adjustment block;
said driven section having a first end and a second end, said first end connected to said lower end of diaphragm cutter assembly, said second end of driven section terminating in a tapered exit, and further comprising at least one upstream pressure transducer and at least one downstream pressure transducer;
said fluid pressure system connected to the high pressure fluid input connection of said VLD assembly;

3. The process of claim 2 wherein said diaphragm is made of a material selected from the group consisting of aluminum, stainless steel, copper, steel, iron, or polymer.

4. The process of claim 2 wherein the ratio of the length of said driver section to the length of said driven section is between 1:2 and 1:50.

5. The process of claim 4 wherein said ratio is 1:15.

6. The process of claim 2 wherein said diaphragm has a thickness between 0.01 to 0.5 mm.

7. The process of claim 2 wherein said exit has a diameter of between 1 and 34 cm.

8. The process of claim 7 wherein said diameter is between 2.54 cm and 10.19 cm.

9. The process of claim 1 further comprising exposing the shock model to a second shock generator output that is a force equivalent of the output.

10. The process of claim 1 further comprising capturing and recording cumulative exposure of the shock model at least one additional output of the shock generator or a component thereof, the component selected from the group consisting of: peak blast overpressure, force, and multi-axis acceleration, multi-axis orientation, impulse and rate of rotation.

11. The process of claim 1 further comprising powering said sensor platform with a power supply electrically connected to said sensor platform, wherein said sensor platform further comprises:
at least one 3-axial accelerometer, at least one 3-axial angular velocity sensor, a pressure transducer array comprising at least one pressure transducer, at least one microprocessor, a solid state data storage unit and optionally includes an analog/digital multiplexer, a wireless interface, an internal/external memory location or a display unit;
wherein said at least one 3-axial accelerometers, said at least one 3-axial angular velocity sensors and said pressure transducer array are electrically connected to said microprocessor, said microprocessor electrically connected to said external solid state data storage device, said microprocessor optionally connected to said analog/digital multiplexer, said wireless interface, said display unit and said internal/external memory location.

12. The process of claim 11 wherein said internal/external memory location is an SD card or otherwise a flash memory device.

13. The process of claim 1 wherein the sensor platform is used to model the effect of a blast event experienced by said shock model.

14. The process of claim 1 wherein the sensor platform is calibrated against blast injury metrics.

15. The process of claim 1 wherein the relating step is included.

16. The process of claim 1 wherein the sensor platform is attached to or in the vicinity of a test subject or object, wherein said sensor platform and said test subject or object is placed on axis beneath the exit of the shockwave generator in the path of the blast event or off axis beneath and adjacent to the exit of the shockwave generator in the path of the blast event.

17. The process of claim 1 wherein cumulative blast data is acquired by said sensor platform and correlated with a level of at least one biomarker indicative of blast injury to predict blast injury severity to the a specific organ, the whole body, or the brain.

18. A system of measuring cumulative blast shock comprising:
a sensor platform;
an algorithm operating on a microprocessor for analyzing the data recorded by the sensor platform to measure the cumulative blast exposure to injury metrics.

19. The system of claim 18 wherein the sensor platform is incorporated with a helmet or vest to record cumulative blast exposure.

20. The system of claim 18 wherein the cumulative blast data may be viewed in real time at a remote location to compare said data with known blast injury metrics.
